(19) United States
(12) Patent Application Publication
(10) Pub. No.: US 2012/0129552 A1
(43) Pub. Date: May 24, 2012

(54) INTEGRATED MOBILE ORDERING SYSTEM

(76) Inventor: Gerard SKYBEY, Rozelle (AU)

(21) Appl. No.: 13/303,557

(22) Filed: Nov. 23, 2011

(30) Foreign Application Priority Data
Nov. 23, 2010 (AU) 2010905164

(51) Int. Cl. G06Q 30/06; H04W 4/02

(52) U.S. Cl. 455/456.3; 705/26.41; 705/27.1

(57) ABSTRACT

A mobile requisition system; said mobile requisition system including an internet and GPS enabled mobile communication device; said mobile communication device interacting over internet-based services with a Broking Facility in a first instance to acquire information of goods and or services from participating goods and or service providers; said mobile communication device interacting over said internet in a second instance with said Broking Facility to purchase a said good or service from a selected said participating goods and services provider; said mobile communication device interacting over said internet in a third instance to transfer payment to said provider; said mobile communication device enabled to display data providing evidence of said purchase and said payment.

The present invention relates to acquisition of consumer useable data and, more particularly, to mobile acquisition of such data and remote transactions for acquisition of goods or services.

### BACKGROUND

The purchase of goods and services through the use of the internet has become a well-known and increasingly popular practice. Typically, the purchase is effected by a user logging on to a web site of the provider of the goods or services, or on to a third party web site such as e-bay or a trading post site.

Many internet enabled payment systems are available for such purchases, for example via PayPal, BPay and like financial services.

However, consumers have limited ability to procure high volume and low value items through mobile devices, such as the preordering and payment for small purchases, for example takeaway food, theatre tickets, a restaurant booking and meal, to give just some examples.

It is an object of the present invention to address or at least ameliorate some of the above disadvantages.

### Notes

1. The term “comprising” (and grammatical variations thereof) is used in this specification in the inclusive sense of “having” or “including”, and not in the exclusive sense of “consisting only of”.

2. The above discussion of the prior art in the Background of the invention, is not an admission that any information discussed therein is citable prior art or part of the common general knowledge of persons skilled in the art in any country.

### BRIEF DESCRIPTION OF INVENTION

Accordingly, in a first broad form of the invention, there is provided a mobile requisition system; said mobile requisition system including an internet and GPS enabled mobile communication device; said mobile communication device interacting over internet-based services with a Broking Facility in a first instance to acquire information of goods and or services from participating goods and or service providers; said mobile communication device interacting over said internet in a second instance with said Broking Facility to purchase a said good or service from a selected said participating goods and services provider; said mobile communication device interacting over said internet in a third instance to transfer payment to said provider; said mobile communication device enabled to display data providing evidence of said purchase and said payment.

In any further broad form of the invention there is provided a mobile communication device requisition system, for procurement of goods and services, said mobile communication device requisition system comprising:
a. A store and forward centre which receives and stores inventory data from a plurality of goods and service providers, said store and forward centre generating a searchable browser from said inventory data;
b. A graphical user interface for providing access to said searchable browser to subscribers of said mobile communication device requisition system, for transmission of geographical location data, for inputting of a user inquiry and for outputting at least one purchase request to said store and forward centre;
c. A payment centre in communication with said mobile communication device; said payment centre configured to execute electronic funds transfer from said subscribers of said mobile communication device requisition system to said goods and service provider.
In yet a further broad form of the invention there is provided a non-transitory computer-readable storage medium having stored thereon or therein a computer-executable set of instructions, said instructions adapted to perform the steps of:
   receiving inventory data from a plurality of goods and service providers;
   generating a searchable browser containing available goods and services from said goods and service providers;
   allowing subscribers to a mobile communication device requisition system access to said searchable browser via a mobile communication device;
   filtering said access to said searchable browser based on the geographical location of said mobile communication device;
   selection of desired goods and/or services from a selected goods and service provider;
   contacting said selected goods and service provider;
   contacting a payment centre for execution of an electronic funds transfer from said subscribers of said mobile communication device requisition system to said selected goods and service provider;
   dispensing confirmation data to said selected goods and service provider, and
   dispensing corresponding confirmation data to said subscribers of said mobile communication device requisition system.
   In a preferred form the broking facility is implemented as a store and forward facility.

Preferably, said participating goods and services providers upload data of available goods and or services provided by said participating goods and services providers to data storage media managed by said Broking Facility.

Preferably, said mobile communication device uploads user details and current location to said Broking Facility through an application resident on said mobile communication device.

Preferably, said Broking Facility provides details to said mobile communication device of goods and or services provided by said participating goods and services providers within a nominated distance from said current location.

Preferably, said user orders from a selected said participating goods and or services provider a said good or service selected from goods and services displayed on said mobile communication device.

Preferably, said user transfers payment for said good or service through an electronic funds transfer system by means of said mobile communication device; said Broking Facility issuing to said mobile communication device evidence of payment for a said good or service purchase.

Preferably, said Broking Facility confirms said payment for said good or service to said selected participating goods and or services provider; said Broking Facility providing confirmation data to said provider for said good or service purchase.

Preferably, said Broking Facility provides corresponding confirmation data to said mobile communication device confirming receipt of payment for said good or service purchase.

Preferably, said corresponding confirmation data is stored in memory of said mobile communication device; said corresponding data available for display to said selected goods and or service provider at time and location of redemption of said good or service.

Preferably, said corresponding confirmation data is in the form of a code displayable on a display screen of said mobile communication device; said code readable by a code reader of said selected goods and or services provider; said code corresponding to said confirmation data issued to said provider by said Broking Facility.

Preferably, said evidence of payment is in the form of a user name and code; said user name and code available for display on said mobile device for viewing by said selected goods and or services provider; said user name and code correlating with a user name and code issued to said selected goods and or services provider by said Broking Facility.

Preferably, said evidence of payment is in the form of an image of a ticket specific to access to a venue or performance purchased by said user; said image made available for display on said mobile communication device.

In another broad form of the invention, there is provided a method of acquisition of a good or service from participating goods and or services providers; said method including the steps of:
a. uploading current location and user identification data from a mobile communication device to a Broking Facility,
b. downloading for display on said mobile communication device available goods and services from goods and services providers within a nominated vicinity of said current location,
c. selecting a desired good or service from displayed said goods and services,
d. arranging payment for said selected good or service by means of said mobile communication device through an electronic funds transfer system,
e. receiving data on said mobile communication device confirming payment for said selected good or service.
f. redeeming said selected good or service on display of said data to a provider of said good or service.

Preferably, said method includes the further steps of:
a. participating providers of goods and services uploading data relating to available goods and services to storage media managed by said Broking Facility,
b. said Broking Facility confirming payment for a selected good or service by a said user; said Broking Facility providing corresponding confirmation of payment data to said user and to a provider of said selected good or service.

Preferably, said acquisition is facilitated by an application resident on said mobile communication device; said application available for download to said communication device from said Broking Facility or another third party application distribution service.

In yet a further broad form there is provided a mobile communications device having a display and a position determination system incorporated therein; the position determination system and display in communication with a processor which in turn is in communication with a communication module, all located within said device; said processor filtering data received by said communications module whereby only data linked to a specific geographic location is available for display on said display.

Preferably the data representative of those geographic locations is transmitted from those geographic locations to a store and forward centre which, in turn, communicates said data to said device.

### BRIEF DESCRIPTION OF DRAWINGS

Embodiments of the present invention will now be described with reference to the accompanying drawings wherein:

FIG. 1 is a diagrammatic representation of the main element of an integrated ordering system according to a preferred embodiment of the invention,

FIG. 2 is a view of a mobile communication device with a number of applications resident on the device, including an application according to the present invention,

FIG. 3 is a first screen displayed on the device of FIG. 2 when the application is activated,

FIGS. 4 to 10 are a further series of displays on said mobile communication device enabling selection, purchase and payment for a good or service according to a preferred embodiment of the invention;

FIG. 11, illustrates in block diagram form, a particular implementation of hardware components for a mobile requisition system in accordance with a further embodiment.

### DETAILED DESCRIPTION OF PREFERRED EMBODIMENTS

The present invention provides for the procurement of a good or service through the use of mobile communication devices which are both internet and Global Positioning System (GPS) enabled as well as having a touch screen display. Such devices include for example those hand-held devices running on the iOS system by Apple®, the Android® system by Google®, RIM® by Blackberry® or Nokia's Symbian® system.

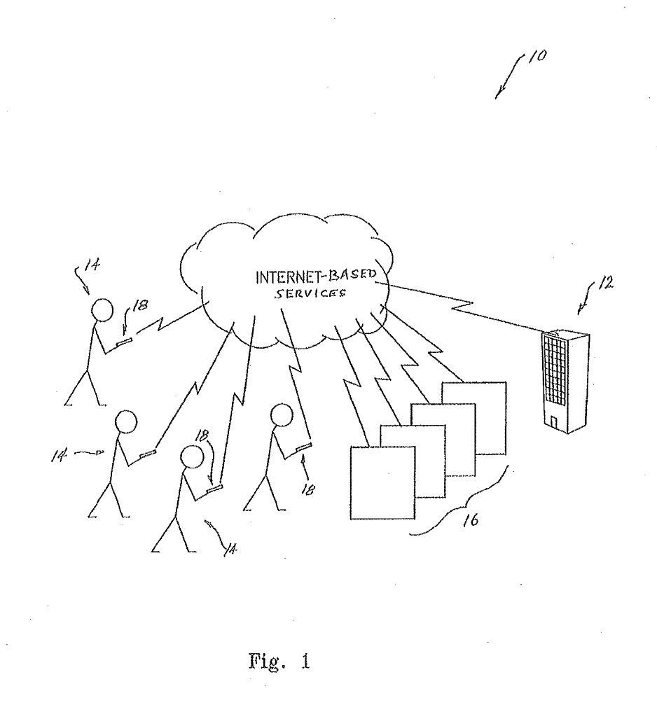

With reference to FIG. 1, the system 10 of the invention provides for a Broking Facility 12 acting as a facilitator between users 14 and providers of goods and services 16. Participating goods and or service providers 16 upload to the Broking Facility 12 details of the goods and services offered. These are stored by the Broking Facility, either on in-house servers and databases or through management of data integrated to “cloud” based services through the internet using HTTP or SOAP internet protocols, for example.

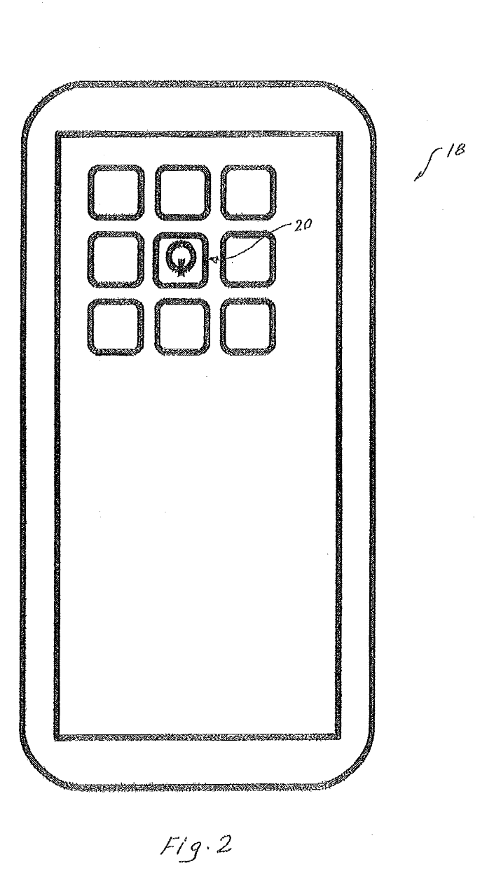

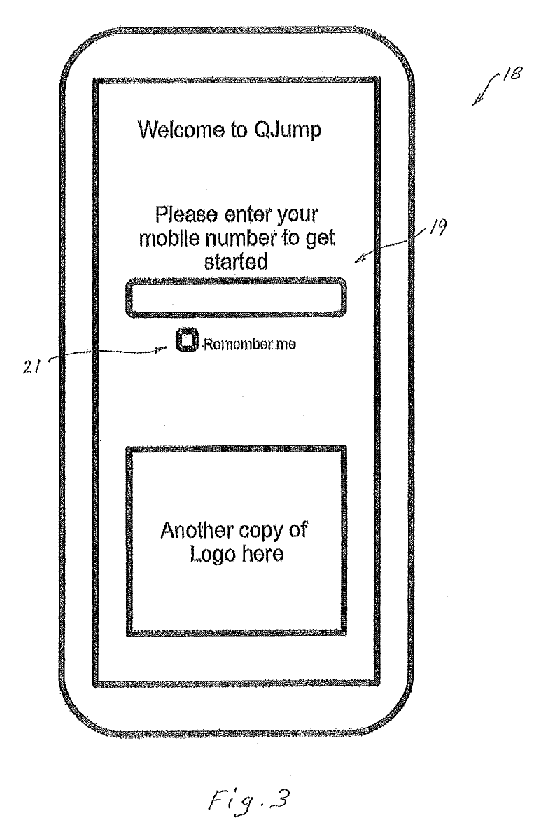

A user 14 of the system 10 accesses the Broking Facility's web site, using an application 20 (see FIG. 2) installed on the user's mobile communication device 18. The application may be available for download from the Broking Facility web site or from another third party application distribution service. The data transferred from the user's device 18 includes the user's details and the current GPS location of the device. Access to the system may be provided through the entry of some identifying code, such as for example by entry of the mobile communication device's registration number 19, as shown in FIG. 3, or an email address. For convenience, the user can nominate that the identification is saved 21 for future use.

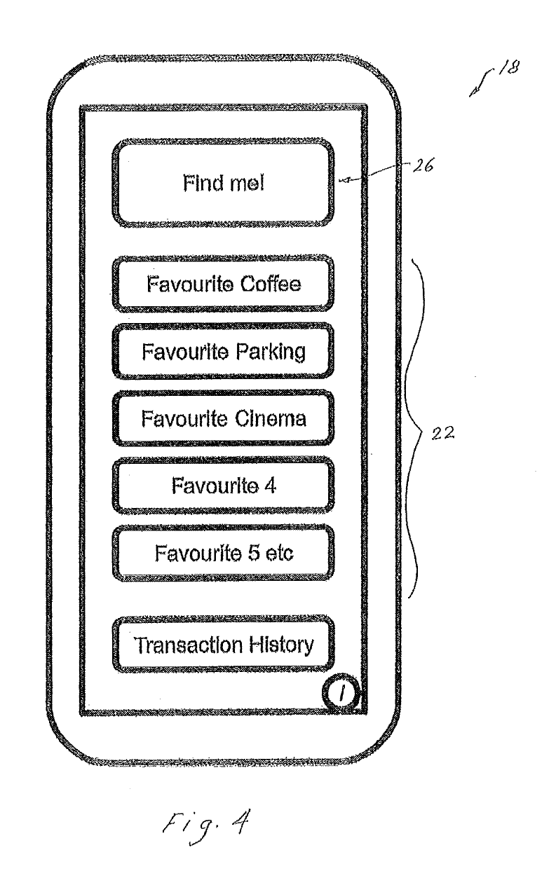

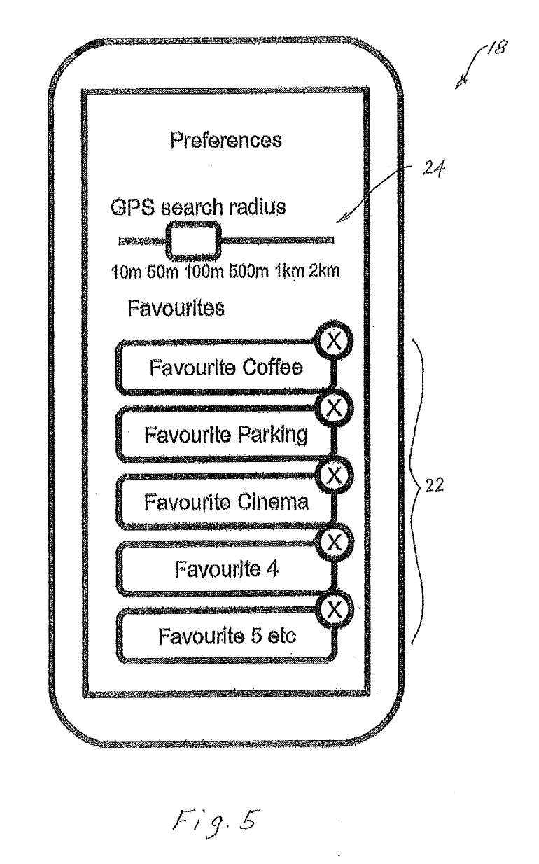

Referring to FIGS. 4 and 5, via the application 20 resident on the device 18, a user 14 may nominate the type of good or service 22 sought and an area, for example expressed as a distance 24, within which the acquisition of the good or service is required. The application provides that a user may store in the memory of the device, a number of favourite suppliers 22.

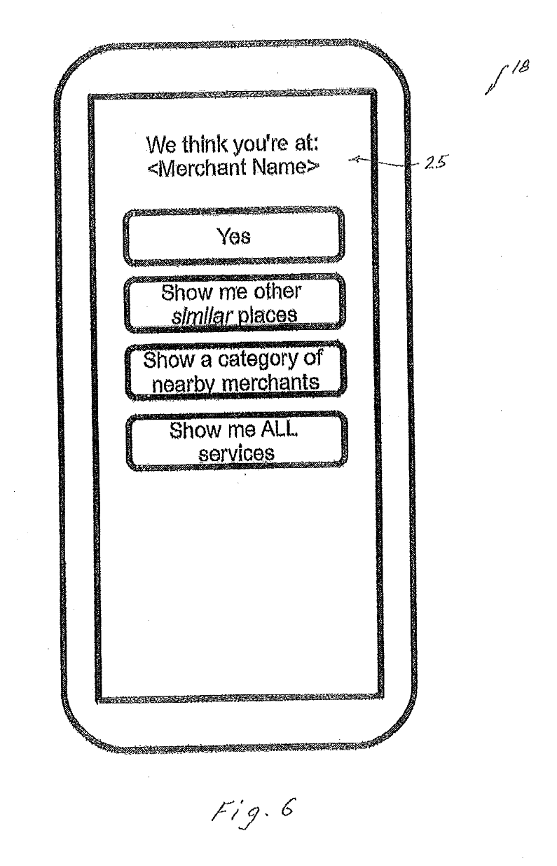

A “Find Me” option utilizes the GPS coordinates transmitted by the device 18 to allow the Broking Facility to identify the location of the user and provide information of goods and service providers at that location or within distance specified by the user. If GPS reception is not available or is inadequate at the user's current location, the BROKING FACILITY may send a message to the device explaining “no GPS signal” and give the user the option to send a text message containing some geographical feature, for example a name of a nearby business to establish a location. The BROKING FACILITY may then respond with the location 25 (see FIG. 6) at which the user appears to be and request confirmation.

As a result of the user's inquiry, the database managed by the Broking Facility is searched and data relevant to the inquiry from the user downloaded to the user's mobile communication device 18. Typically the information thus made available to the user's device will include a listing of goods and or service providers (if any) within the radial distance specified by the user. Embedded in each listing will be details of the goods or services available, possibly accompanied by images and prices.

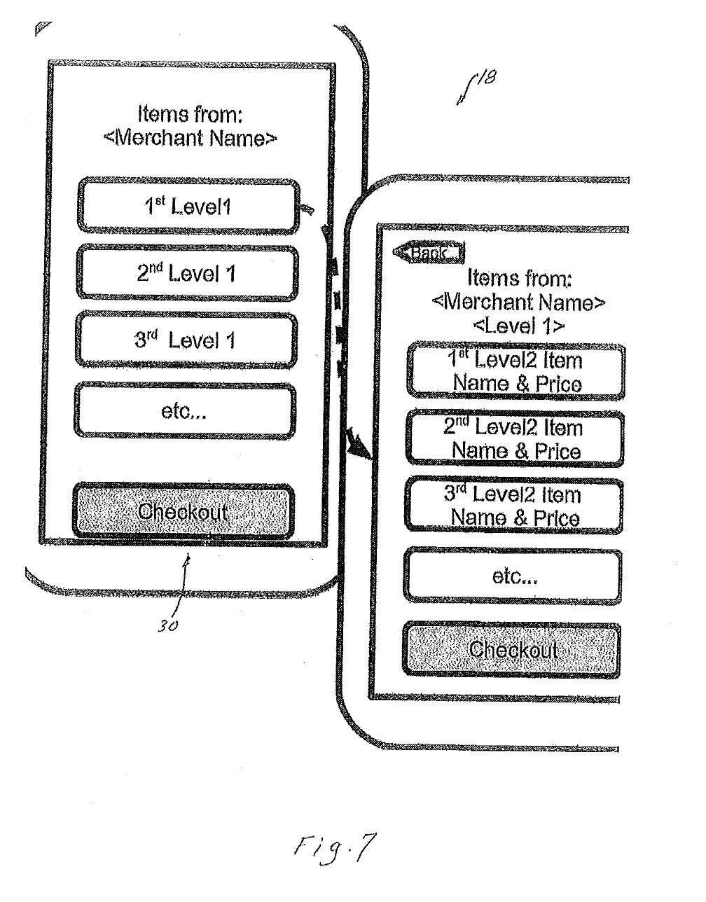

As shown in FIG. 7, the display provided to the user's device 18 may include a hierarchic listing of the goods or services, arranged for example as Category Name/Sub-Category Name/Item Name. By this means the user can find a desired item and select it for addition to a “shopping basket” by tapping a “Checkout” button on the display.

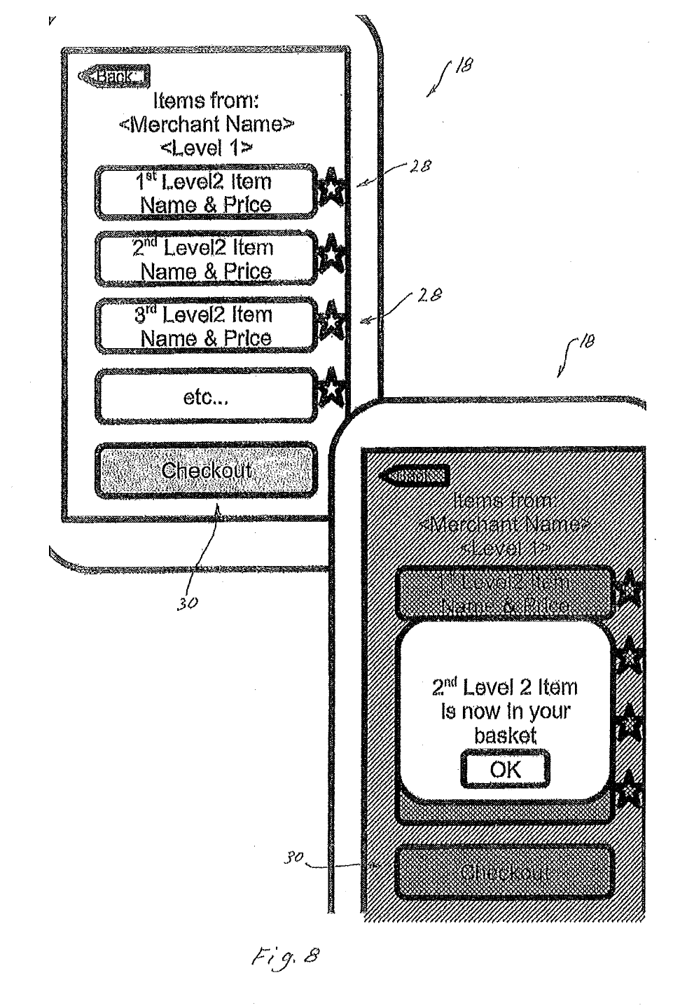

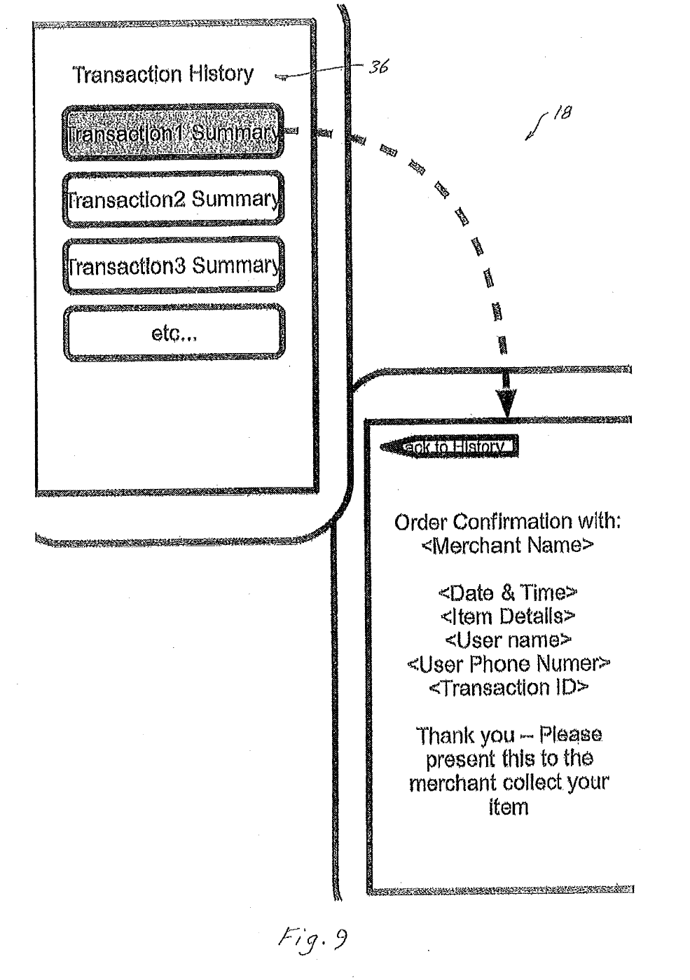

Items may be saved as “favourites” for storage in memory as mentioned above, and may include such frequently used goods and services as coffee outlets, parking stations and cinemas which the user will wish to frequent from time to time. An icon 28 may be provided in the display alongside a goods or service provider's name and at individual items as shown in FIG. 8. By tapping the icon 28, the icon's status changes to indicate that the provider or item is a saved favourite.

If any are available and meet the user's needs, the user selects a good or service by tapping a “Checkout” button 30 displayed on the device 18, and authorises payment. Optionally, the user may specify a preferred time at which redemption of the good or service is required. The selection and payment details are uploaded from the device to the Broking Facility. Payment may be made through one of the well-established electronic fund transfer systems, such as for example the PayPal system.

The selection of the good or service by the user is transmitted by the Broking Facility to the provider together with confirmation of payment. Also transmitted to the provider is data which allows the provider to identify the user as the one to whom the good or service should be provided when the user presents for redemption of the good or service purchased.

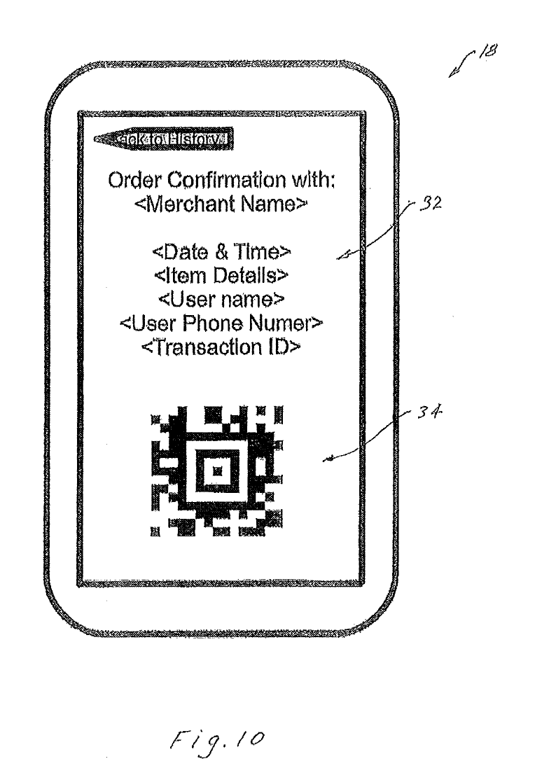

Corresponding confirmation and identifying data 32 (see FIG. 10) is transmitted to the mobile communication device of the user. This information may include the provider's name, the date and time of the transaction, identification details of the item purchased, the user's name and mobile number and a transaction identification. Alternatively, confirmation data may comprise of a user name and identifying code.

In one preferred form, the data transmitted to the user may include a barcode or Quick Response (QR) code 34, unique to the purchase of the good or service. The application resident on the user's communication device is enabled to display this bar, or QR code when the user presents at the provider of the good or service, and the provider may read the code with a suitable scanner.

In another form, the Broking Facility may transmit to both the provider of the good and service and the user, a user name and identifying code for example which the user may then recite or display to the provider in order to redeem the purchase.

In yet another form, in the case where the good or service purchased by the user is access to a venue or performance, the data transferred by the Broking Facility to the user's mobile communication device may be the image of a ticket which, when displayed on the device 18 gives entry to the venue or performance.

Preferably, the application may include a history folder 36 of past transactions for future reference.

In Use

The system of the invention provides a level of convenience in that transactions can be concluded in advance of the actual acquisition of the good or service by a user of the system. Thus in the case where the user seeks a good or service in the near future and in his or her current vicinity, the purchase can be prearranged so that the user avoids the need for queuing, or the time required for payment in a face to face transaction. For redemption of the product or service, the user need only present at the location of the good or service provider and display the confirmation and identifying data on the user's mobile communication device, or provide a user name and identifying code, for example.

In Use—Hardware Components

The present invention or any part(s) or function(s) thereof, including, e.g., the mobile communication device or the Broking Facility, may be implemented using hardware, software, or a combination thereof, and may be implemented in one or more computer systems or other processing systems. A computer system for performing the operations of the present invention and capable of carrying out the functionality described herein can include one or more processors connected to a communications infrastructure (e.g., a communications bus, a cross-over bar, or a network). Various software embodiments are described in terms of such an exemplary computer system. After reading this description, it will become apparent to a person skilled in the relevant art(s) how to implement the invention using other computer systems and/or architectures.

The computer system can include a display interface that forwards graphics, text, and other data from the communication infrastructure (or from a frame buffer) for display on a display unit. The display interface can communicate with a browser. The computer system also includes a main memory, preferably a random access memory, and may also include a secondary memory and a database. The secondary memory may include, for example, a hard disk drive and/or a removable storage drive, representing a floppy disk drive, a magnetic tape drive, an optical disk drive, etc. The removable storage drive reads from and/or writes to a removable storage unit in a well known manner. The removable storage unit can represent a floppy disk, magnetic tape, optical disk, etc. which is read by and written to by the removable storage drive. As will be appreciated, the removable storage unit can include a computer usable storage medium having stored therein computer software and/or data.

The computer system may also include a communications interface which allows software and data to be transferred between the computer system and external devices. The terms “computer program medium” and “computer usable medium” are used to refer generally to media such as the removable storage drive, a hard disk installed in the hard disk drive, and signals. These computer program products provide software to the computer system.

Computer programs or control logic are stored in the main memory and/or the secondary memory. Computer programs may also be received via the communications interface. Such computer programs or control logic (software), when executed, cause the computer system or its processor to perform the features and functions of the present invention, as discussed herein.

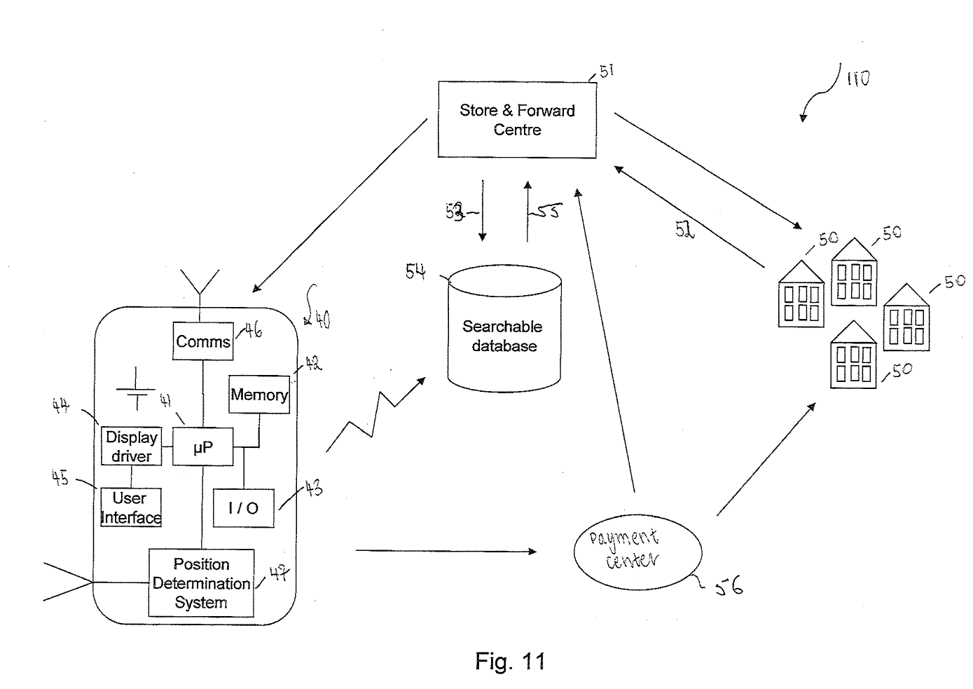

With reference to FIG. 11, there is illustrated in block diagram form, a particular implementation of components for mobile requisition system 110 in accordance with a specific embodiment of the present invention.

In the present embodiment of the mobile requisition system 110, goods and service providers 50 may provide a store and forward centre 51 with inventory data 52. This inventory data 52 may contain information about price and geographic location of stores. On receipt of inventory data from goods and service providers 50, the store and forward centre 51 transmits data elements representative of the inventory data 53 to a searchable database 54.

The searchable database 54 is accessible from a mobile communication device 40. The mobile communication device 40 includes a microprocessor 41 which executes instructions stored in a memory 42 and gives effect to those instructions via an input-output unit 43, a display driver 44 and communications module 46. The display driver 44 with a user interface 45. The microprocessor 41 is in communication with a position determination system 47.

On accessing the searchable database 54, via the store and forward centre 51, the mobile communication device 40 can access data elements 55 representative of selected inventory data 53 which match criteria determined by a user of said communications device 40. The criteria are input by input output device 43 and the comparison is performed by microprocessor 41.

On selection of a specific inventory item a user of the mobile communications device 40 can trigger an order transaction with a goods and service provider 50 and then, in a subsequent step, instigate a payment transaction via said store and forward centre 51 with a payment centre 56.

The criteria which are matched include geographical criteria linked to a determination by the mobile communications device 40 of its geographic location.

The geographical criteria are linked with identity information which uniquely identify the individual service providers 50 and their specific offerings of goods and/or services.

The system and therefore forms a gateway moderated by geographical location to service providers who have “pushed” their unique identity information to the store and forward centre 51 for storage on the searchable database 54. This arrangement allows the user access to the goods and services of any one or all of the participating service providers 50. The user does not have to “go looking”. Rather the service providers come to the user and their presentation to the user on the mobile communications device 40 is moderated by geographical position of the mobile communications device 40.

Specifically the mobile communications device 40 has a display and a position determination system incorporated therein; the position determination system and display in communication with a processor which in turn is in communication with a communication module, all located within said device; said processor filtering data received by said communications module whereby only data linked to a specific geographic location is available for display on said display.

Preferably the data representative of those geographic locations is transmitted from those geographic locations to a store and forward centre 51 which, in turn, communicates the data to the device 40.

The above describes only some embodiments of the present invention and modifications, obvious to those skilled in the art, can be made thereto without departing from the scope of the present invention.

1. A mobile requisition system; said mobile requisition system including an internet and GPS enabled mobile communication device; said mobile communication device interacting over internet-based services with a Broking Facility in a first instance to acquire information of goods and or services from participating goods and or service providers; said mobile communication device interacting over said Internet in a second instance with said Broking Facility to purchase a said good or service from a selected said participating goods and services provider; said mobile communication device interacting over said Internet in a third instance to transfer payment to said provider; said mobile communication device enabled to display data providing evidence of said purchase and said payment.

2. The system of claim 1 wherein said participating goods and services providers upload data of available goods and or services provided by said participating goods and services providers to data storage media managed by said Broking Facility.

3. The system of claim 1 wherein said mobile communication device uploads user details and current location to said Broking Facility through an application resident on said mobile communication device.

4. The system of claim 1 wherein said Broking Facility provides details to said mobile communication device of goods and or services provided by said participating goods and services providers within a nominated distance from said current location.

5. The system of claim 1 wherein said user orders from a selected said participating goods and or services provider a said good or service selected from goods and services displayed on said mobile communication device.

6. The system of claim 1 wherein said user transfers payment for said good or service through an electronic funds transfer system by means of said mobile communication device; said Broking Facility issuing to said mobile communication device evidence of payment for a said good or service purchase.

7. The system of claim 6 wherein said Broking Facility confirms said payment for said good or service to said selected participating goods and or services provider; said Broking Facility providing confirmation data to said provider for said good or service purchase.

8. The system of claim 7 wherein said Broking Facility provides corresponding confirmation data to said mobile communication device confirming receipt of payment for said good or service purchase.

9. The system of claim 8 wherein said corresponding confirmation data is stored in memory of said mobile communication device; said corresponding data available for display to said selected goods and or service provider at time and location of redemption of said good or service.

10. The system of claim 7 wherein said corresponding confirmation data is in the form of a code displayable on a display screen of said mobile communication device; said code readable by a code reader of said selected goods and or services provider; said code corresponding to said confirmation data issued to said provider by said Broking Facility.

11. The system of claim 6 wherein said evidence of payment is in the form of a user name and code; said user name and code available for display on said mobile device for viewing by said selected goods and or services provider; said user name and code correlating with a user name and code issued to said selected goods and or services provider by said Broking Facility.

12. The system of claim 6 wherein said evidence of payment is in the form of an image of a ticket specific to access to a venue or performance purchased by said user; said image made available for display on said mobile communication device.

13. A method of acquisition of a good or service from participating goods and or services providers; said method including the steps of:
a. uploading current location and user identification data from a mobile communication device to a Broking Facility,
b. downloading for display on said mobile communication device available goods and services from goods and services providers within a nominated vicinity of said current location,
c. selecting a desired good or service from displayed said goods and services,
d. arranging payment for said selected good or service by means of said mobile communication device through an electronic funds transfer system,
e. receiving data on said mobile communication device confirming payment for said selected good or service.
f. redeeming said selected good or service on display of said data to a provider of said good or service.

14. The method of claim 13 wherein said method includes the further steps of:
a. participating providers of goods and services uploading data relating to available goods and services to storage media managed by said Broking Facility,
b. said Broking Facility confirming payment for a selected good or service by a said user; said Broking Facility providing corresponding confirmation of payment data to said user and to a provider of said selected good or service.

15. The method of claim 13 wherein said acquisition is facilitated by an application resident on said mobile communication device; said application available for download to said communication device from said Broking Facility or another third party application distribution service.

16. Media containing code which when executed on a processor implements the method of claim 13.

17. Media containing code which when executed on a processor implements the system of claim 1.

18. A mobile communication device requisition system, for procurement of goods and services, said mobile communication device requisition system comprising:
a. A store and forward centre which receives and stores inventory data from a plurality of goods and service providers, said store and forward centre generating a searchable browser from said inventory data;
b. A graphical user interface for providing access to said searchable browser to subscribers of said mobile communication device requisition system, for transmission of geographical location data, for inputting of a user inquiry and for outputting at least one purchase request to said store and forward centre;
c. A payment centre in communication with said mobile communication device; said payment centre configured to execute electronic funds transfer from said subscribers of said mobile communication device requisition system to said goods and service provider.

19. A non-transitory computer-readable storage medium having stored thereon or therein a computer-executable set of instructions, said instructions adapted to perform the steps of:
receiving inventory data from a plurality of goods and service providers;
generating a searchable browser containing available goods and services from said goods and service providers;
allowing subscribers to a mobile communication device requisition system access to said searchable browser via a mobile communication device;
filtering said access to said searchable browser based on the geographical location of said mobile communication device;
selection of desired goods and/or services from a selected goods and service provider;
contacting said selected goods and service provider;
contacting a payment centre for execution of an electronic funds transfer from said subscribers of said mobile communication device requisition system to said selected goods and service provider;
dispensing confirmation data to said selected goods and service provider, and
dispensing corresponding confirmation data to said subscribers of said mobile communication device requisition system.

20. A mobile communications device having a display and a position determination system incorporated therein; the position determination system and display in communication with a processor which in turn is in communication with a communication module, all located within said device; said processor filtering data received by said communications module whereby only data linked to a specific geographic location is available for display on said display.

21. The communications device of claim 20 wherein the data representative of those geographic locations is transmitted from those geographic locations to a store and forward centre which, in turn, communicates said data to said device.
